(19) United States
(12) Patent Application Publication
(10) Pub. No.: US 2023/0191282 A1
(43) Pub. Date: Jun. 22, 2023

(54) Device For Bind And Elute Chromatography Using Membranes, And Method Of Manufacture

(71) Applicant: Merck Millipore Ltd., Carrigtwohill (IE)

(72) Inventors: Kevin Rautio, Burlington, MA (US); Sean Foley, Burlington, MA (US); Gerado Cedrone, Burlington, MA (US); Matthew T. Stone, Burlington, MA (US)

(21) Appl. No.: 17/926,775

(22) PCT Filed: Apr. 26, 2021
(86) PCT No.: PCT/US2021/029152

§ 371 Date: Nov. 21, 2022

Related U.S. Application Data
(60) Provisional application No. 63/037,262, filed on Jun. 10, 2020.

(51) Int. Cl. B01D 15/22; B01D 15/38

(52) U.S. Cl. CPC B01D 15/22; B01D 15/3809

(57) ABSTRACT

Integral chromatography unit having an inlet and an outlet, and comprising one or more membranes interposable in the internal volume of the unit between the inlet and outlet. In certain embodiments, each of the membranes is allotted adequate space within the unit to swell by the placement of one or more spacers. Fluid entering the unit through a fluid inlet passes the membrane(s) and spacer(s) prior to exiting the unit through a fluid outlet.

This application claims priority of U.S. Provisional Application Ser. No. 63/037,262 filed Jun. 10, 2020, the disclosure of which is incorporated herein by reference in its entirety.

### FIELD

In general, the present disclosure is directed to chromatography units, and in particular, to a disposable or single-use chromatography devices through membranes with applications including membrane based bind/elute chromatography.

### BACKGROUND

Good manufacturing practices and governmental regulations are at the core of many biopharmaceutical manufacturing process. Such manufacturing processes must often undergo mandated, often lengthy and costly validation procedures. For example, the equipment used for the separation and purification of biopharmaceutical products must, for obvious reasons, meet stringent cleanliness requirements. For a single piece of equipment, the associated and reoccurring cost of a single cleaning validation may readily exceed multiple thousands of dollars. To reduce such cleaning validation costs and expenses, and/or to reduce the occasions when cleaning is needed or required, the pharmaceutical and biotech industries are increasingly exploring pre-validated modular, disposable solutions.

Along these lines, there is considerable interest of late in developing a disposable solution to the primary and/or secondary clarification of industrial, laboratory and clinical volumes of raw, pharmaceutically synthesized fluids (e.g., cell cultures). The high-volume, high-throughput requirements of such processes generally favor the use of costly, installed stainless steel apparatus, wherein replaceable cassettes or cartridges (e.g., typically comprising stacks of lenticular filter elements) are installed within a stainless steel housing or like receptacle. At the conclusion of a filtration operation, and removal of the spent cassette or cartridge, the apparatus has to be cleaned and validated, at considerable cost and effort, prior to being used again.

Membrane based devices designed for use in the biopharmaceutical processing industry are typically constructed of all thermoplastic components. This is desirable because the thermoplastics of choice (e.g., polypropylene, polyethylene, polyethersulphone, etc.) are stable in the chemicals and environment they are exposed to. One negative aspect of all thermoplastic devices that utilize secondary molding operations during manufacture is shrinkage. As the thermoplastic cools, it shrinks, thus warping the membrane and creating undesirable voids in the membrane.

Scale-down models may be used for validation of filtration operations, such as viral filtration operations. For example, a sample may be spiked with a known quantity of a virus to simulate contamination, and then removed with a scale-down device. The performance of the device may be measured to ascertain its viral clearance capabilities.

Such devices are typically made of thermoplastics and ae manufactured using an over-molding step where, a “window frame” of thermoplastic (typically polypropylene) is injection molded around the periphery of a rectangular piece of membrane or media, then a bonding step (vibration, hotplate, etc.) is used to attach the subassemblies. In flow-through applications where the separation mechanism is either size exclusion or charge based, the additional void inside the device that is created by shrinking as it cools (and wrinkling the membrane or media), does not negatively affect the device performance. However, in bind and elute mode applications for capture in a chromatography train, any additional void created by a wrinkled membrane will reduce the performance of the device. This performance reduction can be seen in the sharpness of the breakthrough curve and in the efficiency of the elution.

In addition, it is important to create an integral seal of the membrane in the device even when wet or semi-wet membranes are used.

It therefore would be desirable to have a filtration device, such as a bind and elute chromatography device, using one or more membranes coupled with a desired ligand (e.g., Protein A ligand) that remain flat, void-free and sealed in the device.

For further understanding of the nature and these and other objects of the present invention, reference should be had to the following description considered in conjunction with the accompanying drawings.

### SUMMARY

Problems of the prior art have been addressed by embodiments disclosed herein, which relate to an integral chromatography unit having an inlet and an outlet, and comprising one or more membranes positioned in a region of the unit between the inlet and the outlet. Sufficient space between membranes is provided to allow for swelling of the membranes. In some embodiments, fluid entering the unit through an inlet passes through the membrane or membranes prior to exiting the unit through the outlet spaced from the inlet.

In various embodiments, disclosed is a chromatography device comprising a housing having a fluid inlet and a fluid outlet spaced from said fluid inlet; an internal volume in a region between said fluid inlet and said fluid outlet; at least first and second membranes arranged in said internal volume of said housing; and at least one spacer arranged between said first and second membranes. The resulting flow path through the membrane or membranes (and the spacer) promotes use of the unit for chromatography applications, including bind/elute chromatography operations of, for example, biopharmaceutical fluids.

In some embodiments, the at least one spacer is in the shape of an annulus; e.g., a washer or donut-shaped member. In some embodiments, there is a filtration zone within the internal volume of the housing defined by an active membrane area of the at least first and second membranes, and the annulus has an open region arranged within that filtration zone.

In some embodiments, the first membrane is arranged upstream, in the direction of fluid flow during operation of the chromatography device, of the second membrane, and a spacer is arranged between the first and second membranes. In some embodiments, the chromatography device further comprises a porous frit arranged between the fluid inlet and the first membrane. In some embodiments, there may be a porous frit arranged between the fluid outlet and the second membrane that is arranged downstream, in the direction of fluid flow during operation of the chromatography device, of the first membrane. In some embodiments, frits may be arranged both between the fluid inlet and the first membrane, and between the fluid outlet and the second membrane.

Also disclosed are methods of manufacturing such chromatography units.

By providing space for the one or more membranes to swell or expand in the housing by suitably arranging one or more spacers in the internal volume of the housing, the problem of loss of device performance due to an uneven or wrinkled membrane is minimized or resolved.

Thus, disclosed is a membrane-based bind and elute chromatography unit or device wherein the membrane or plurality of membranes remains flat and uniform in the device to minimize voids, thereby maximizing the active membrane area of the device.

In certain embodiments, disclosed is a filtration device having an inlet and an outlet, the device comprising a polymeric framework having a filtration zone and one or more membranes bonded or adhered to the polymeric framework in the filtration zone with one or more spacers separating the membranes in the device.

In certain embodiments, each membrane within a plurality of membranes is the same, e.g., each has the same chemistry and performance characteristics or rating. In certain embodiments, each membrane within a plurality of membranes is varied with different chemistry or performance characteristics in order to obtain a specific performance characteristic for resulting filter unit.

In some embodiments, disclosed is an integral unit having an inlet and an outlet, and comprising at least one membrane, wherein fluid entering the disposable integral unit through the inlet passes through the at least one membrane prior to exiting the unit through the outlet. One or more spacers is arranged in the integral unit, preferably in the form of a washer or annulus, providing a region of expansion of the one or more membranes within the unit. The unit is well-suited for highly productive chromatographic capture of monoclonal antibodies (mAbs) form clarified cell culture by rapid cycling. It may be operated at significantly higher flow rates than is possible with traditional Protein A resins.

### BRIEF DESCRIPTION OF THE DRAWINGS

FIG. 1 is a cross-sectional view of a filtration device in accordance with certain embodiments;

FIG. 2 is a perspective view of a spacer in accordance with certain embodiments;

FIG. 3 is a cross-sectional view of a filtration device in accordance with an alternative embodiment;

FIG. 4 is an exemplary graph of a pressure flow relationship for a 1 mL device in accordance with certain embodiments;

FIG. 5 is a schematic diagram of a system set up, with the system hold-up volume shown between the injection valve and detector in accordance with certain embodiments;

FIG. 6 is an exemplary chromatograph showing UV280 of a 2% acetone pulse used to measure the system hold-up volume in accordance with certain embodiments; and

FIG. 7 is an exemplary breakthrough chromatograph showing the normalized absorbance at 280 nm for a 1 mL device in accordance with certain embodiments.

### DETAILED DESCRIPTION

A more complete understanding of the components, processes and devices disclosed herein can be obtained by reference to the accompanying drawings. The figures are merely schematic representations based on convenience and the ease of demonstrating the present disclosure, and is, therefore, not intended to define or limit the scope of the exemplary embodiments.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used in the specification, various devices and parts may be described as “comprising” other components. The terms “comprise(s),” “include(s),” “having,” “has,” “can,” “contain(s),” and variants thereof, as used herein, are intended to be open-ended transitional phrases, terms, or words that do not preclude the possibility of additional components.

Conventionally, scale-down filtration devices have been made with a single step molding operation. The membrane layer or layers are stacked between two plastic components (and an inlet and an outlet), placed into a thermoplastic mold where the components and membrane are mechanically compressed together, and molten thermoplastic is injected around the periphery to create a seal from the top plastic component to the bottom plastic component. A contact or hotplate welding operation may be used. An integral seal is formed between the membrane or membranes and the device as is an overall weld of the device housing. Membrane screens arranged below each of the membranes may be included in the device. Suitable screens include those made of polypropylene, polyethylene and Nylon. One suitable screen is Naltex extruded netting commercially available from DelStar Technologies, having a thickness of 0.010 inches, a strand count (In) of 13.5 SPI, a strand count (out) of 13.5 SPI, a stand angle of 60 degrees, and a basis weight of 5.50 Oz/10 Ft. Separating the membranes with screens lowers the elution pressure and reduces the variability. In some embodiments, one or more of the spacers 22 may have a membrane screen 25 positioned within the internal diameter of the spacer 22 (FIG. 3), such as by pressing fitting or coupled with an adhesive.

However, the membranes typically are porous hydrogels that require swelling (e.g., typically between 5 and 30% swelling) to achieve optimum functionality. This swelling can result in lower dynamic binding capacity and higher pressure drop performance. Embodiments disclosed herein accommodate the swelling and improve device performance.

Turning now to FIG. 1, there is shown a filtration unit 10 which includes a housing 12 having a fluid inlet 13 and a fluid outlet 14 spaced from the inlet 13. The fluid inlet 13 and fluid outlet 14 may include suitable luer connectors for convenient connection to tubing or the like. The housing is defined by a fluid impervious wall or walls. The inner surface of the housing 12 at the fluid inlet 13 and/or the fluid outlet 14 may have a grid-like surface 8 to enhance fluid distribution in the housing (only shown at the fluid outlet 13 in FIG. 1). The grid-like surface 8 may be integral with the housing or may be a separate piece joined to the housing.

In the embodiment shown, there are a plurality of membranes 15a, 15b, 15c, 15d and 15e arranged in the unit 10. Although in this embodiment five membranes are illustrated, those skilled in the art will appreciate that fewer or more membranes can be used. Membrane 15a is arranged as the upstream membrane. Membrane 15b is arranged downstream, in the direction of fluid flow from the inlet 13 to the outlet 14, of membrane 15a; membrane 15c is arranged downstream, in the direction of fluid flow from the inlet 13 to the outlet 14, of membrane 15b; membrane 15d is arranged downstream, in the direction of fluid flow from the inlet 13 to the outlet 14, of membrane 15c; and membrane 15e is arranged downstream, in the direction of fluid flow from the inlet 13 to the outlet 14, of membrane 15d. Preferably the membranes 15 are each sealed to a surface of a fluid impervious wall of the housing 12, such as by an overmolding process. The overmold material may be the same as the material of the housing, e.g., polyethylene. Thus, the housing top and bottom, and the membrane(s), optional screen(s) and washer(s)s are positioned in a molding machine, and the machine compresses the stack and injects molten polypropylene, for example, around the periphery to weld the top, bottom, membrane/screen/washer stack together. Once assembled, each membrane 15 has an active area, i.e., a region of the membrane available for sample flow, and a membrane inactive area, i.e., region (generally around the membrane perimeter) that is sealed to the housing and therefore unavailable for sample flow. In some embodiments, a porous frit 17 optionally may be positioned between the fluid inlet 13 and the membrane positioned furthest upstream (membrane 15a in the FIG. 1 embodiment), and/or between the fluid outlet 14 and the membrane positioned furthest downstream (membrane 15e in the FIG. 1 embodiment). In some embodiments, the a porous frit 17 may be positioned in the fluid inlet 13 and/or in the fluid outlet 14 of the unit, as shown in FIG. 3. That is, the frit 17 may be pressed fit within the inner diameter of the fluid inlet 13 and/or the fluid outlet 14, rather than being overmolded to the housing of the unit as in the embodiment of FIG. 1. Thus, the outer diameter of a frit so positioned in the inlet or outlet as shown in FIG. 3 is smaller than the outer diameter of a frit positioned as shown in FIG. 1. Suitable frit materials include polyolefins, especially polyethylene. Suitable frit thicknesses may range from about 0.03 inches to about 0.06 inches. Preferably the thickness of the frit is uniform.

Suitable membranes include those suitable for bind/elute chromatography and including a ligand, such as a Protein A ligand, attached thereto. In certain embodiments, the membrane(s) 15 may be a wet membrane that is not dryable, such as a porous hydrogel. Suitable membranes include those disclosed in U.S. Pat. Nos. 7,316,919; 8,206,958; 8,383,782; 8,367,809; 8,206,982; 8,652,849; 8,211,682; 8,192,971; and 8,187,880, the disclosures of which are hereby incorporated by reference. Such membranes include composite materials that comprises a support member that has a plurality of pores extending through the support member and, located in the pores of the support member and essentially filling the pores of the support member, a macroporous cross-linked gel. In some embodiments, the macroporous gel used is responsive to environmental conditions, providing a responsive composite material. In other embodiments, the microporous gel serves to facilitate chemical synthesis or support growth of a microorganism or cell.

In certain embodiments, the membrane or membranes 15 are adhered and sealed to the housing 12 which is preferably made of a polymeric material such as a thermoplastic. Suitable thermoplastics include polyolefins such as polypropylene and polyethylene, blends thereof, and polyethersulphone. The arrangement and sealing of the membranes 15 in the housing 12 is preferably such that all of the fluid entering the fluid inlet 13 of the device 10 must pass through the active area of the membrane or membranes 15 before it reaches the fluid outlet 14 of the device 10.

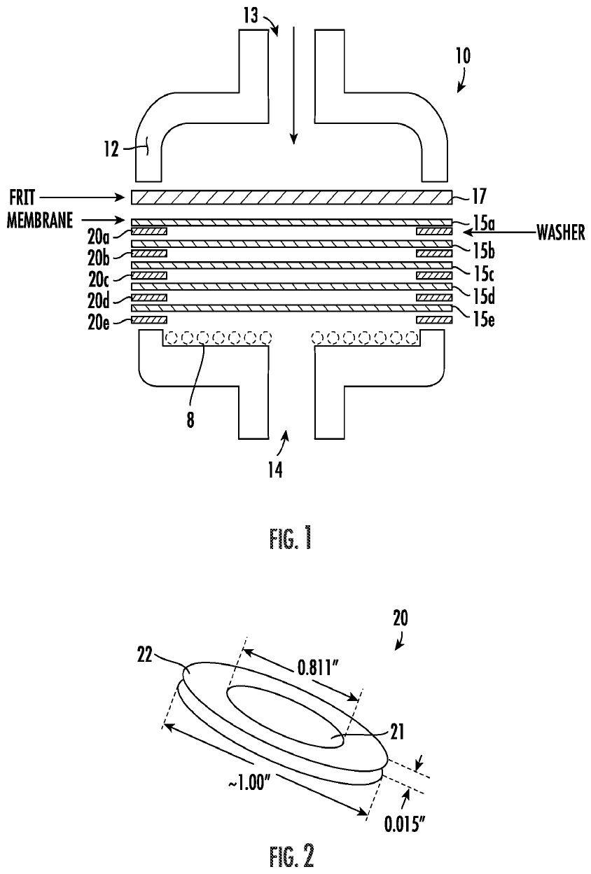

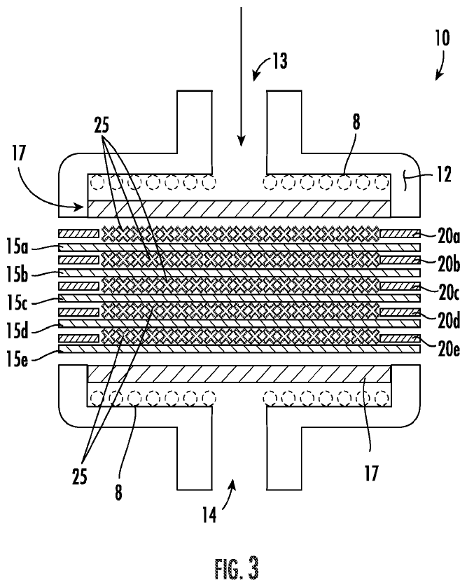

In various embodiments, arranged between one or more of the membranes 15 is a spacer or washer 20 (FIG. 2). In some embodiments, the spacer or wash 20 is defined by a frame 22 or perimeter, which may be an annular perimeter and may be continuous or discontinuous. In the embodiment of FIG. 1, where there are five membranes 15, there may be four washers 20. Thus, washer 20a is arranged between membrane 15a and 15b; washer 20b is arranged between membrane 15b and 15c; washer 20c is arranged between membrane 15c and 15d; and washer 20d is arranged between membrane 15d and 15e. The washers 20 are of a suitable thickness to provide sufficient space for each of the membranes 15 to swell or expand in the housing with minimal or no wrinkling or warpage. Suitable washer thicknesses include 0.010 inches, 0.015 inches, 0.020 inches and 0.030 inches. Washers 20 of other thicknesses could be used, depending on the desired expansion space for the membrane or membranes 15. In certain embodiments, the outside diameter of the washer 20 is the same or substantially the same as the outside diameter of a membrane 15. In certain embodiments, the outside diameter of the washer 20 is sufficient to enable its attachment and sealing to the housing 12.

In certain embodiments, where there is a plurality of washers in a device 10, each of the washers 20 has the same dimensions. In certain embodiments, each washer 20 has an open region 21 that is in fluid communication with the active membrane area of a membrane 15 when in the assembled condition. Preferably the open region 21 of each washer is arranged in the filtration zone of the device 10, the filtration zone being that region in the internal volume of the housing 12 that contains active membrane area (i.e., the area of the membrane available for filtration within the housing 12). As such, the washer 20 does not impede fluid flow or filtration in and through the device 10. In certain embodiments the open region 21 aligns with the active area of the membrane 15. The perimeter or frame 22 of each washer 20 may be non-porous and available for sealing to the inner wall of the housing 12. Suitable materials for the washer 20 include polyester, polyolefins such as polypropylene and polyethylene, polystyrene and polysulphone.

The device can be implemented at a relatively low cost. The device 10 can be reusable, or made as a “single use” item, i.e., “single use” in the sense that at the completion of the desired (or predetermined) operation, the device can either be disposed of (e.g., as is sometimes required by law after filtering certain environmentally-regulated substances) or partially or completely revitalized or recycled (e.g., after filtering non-regulated substances). The presence of one or more washers in the device eliminates variability; i.e., a reduction in data spread when measuring elution pressure vs. dynamic binding capacity at 10% breakthrough and when measuring elution volume vs. elution delay.

### EXAMPLE

Connecting A Protein A Membrane Device Containing 1 mL of Membrane

An appropriately sized chromatography system with a fraction collector (i.e. ÄKTA™ Avant 25 or ÄKTA™ Pure 25) is primed with equilibration buffer at a flow rate of 10 mL/min until the UV absorbance at 280 nm (UV280), pH, pressure, and conductivity detectors have reached a constant value. Suitable tubing is attached to the inlet and outlet of the device, and a zero volume luer connector is used to connect the inlet tubing to the outlet tubing. The tubing is flushed with equilibration buffer at a flow rate of 10 mL/min unit the UV280, pH, pressure and conductivity detectors have reached a constant value. The flow is stopped and the zero volume luer connector is removed. The outlet is connected to outlet tubing with a luer fitting while avoiding the introduction of air into the device. Equilibration buffer is flowed in a reversed direction at a flow rate of 1 mL/min (outlet→inlet) to remove any air bubbles, and the inlet is connected to inlet tubing via the luer fitting.

The device is oriented so that the outlet is on top and the outlet cap is removed. The outlet is connected to outlet tubing with a luer fitting while avoiding the introduction of air into the device. Equilibration buffer is flowed in a reversed direction at a flow rate of 1 mL/min (outlet→inlet) to remove any air bubbles, and the inlet is connected to inlet tubing via the luer fitting. Equilibration buffer is introduced in the reverse direction through the device at a flow rate of 1 mL/min. The flow rate is gradually increased to 10 mL/min and the pressure drop (DeltaC Pressure) is monitored across the device. Flow is continued at a rate of 10 mL/min until the pressure is stable. The pressure drop (DeltaC Pressure) should not exceed 100 psi.

50 MV of equilibration buffer is flowed in the forward direction through the device at a flow rate of 10 mL/min. This flow is continued until the UV280, pH, pressure, and conductivity detectors have reached a constant value.

Pressure Flow Characterization

Target Pressure Drop

Preferably the flow rate is adjusted to reach an operating delta column pressure of 2 bar. The observed pressure will depend on the buffering solutions selected. To identify the optimal flow rate, blank runs at flow rates of 7, 8, 9 and 10 MV/min may be run. During the blank runs, the mAb solution is not loaded onto the device. The remainder of the steps are the same.

Blank Run Method
1. All of the buffers are connected through either system pump A or system pump B. The equilibration buffer is flowed at 10 mL/min over the column bypass until the UV280, pH, pressure, and conductivity detectors reach a constant value. The UV280 signal is set to zero.
2. The target flow rate is selected (7, 8, 9, or 10 MV/min).
3. The following steps to survey the operating flow rates are also shown in Table 1 below.
   a. Step P1: A 10 mL pump is used wash to prime the equilibration buffer. The device is equilibrated with 10 MV of equilibration buffer at the target flow rate
   b. Step P2: A 10 mL pump wash is used to prime the high salt buffer. The device is washed with 10 MV of the high salt buffer at the target flow rate
   c. Step P3: A 10 mL pump wash is used to prime the equilibration buffer. The device is washed with 10 MV of the equilibration buffer at the target flow rate
   d. Step P4: A 10 mL pump wash is used to prime the elution buffer. The device is flowed with 15 MV of the elution buffer at the target flow rate
   e. Step P5: A 10 mL pump wash is used to prime the CIP solution. The device is cleaned with 10 MV of CIP solution at the target flow rate.
   f. Step P6: A 10 mL pump wash is used to prime the equilibration buffer. The device is equilibrated with equilibration buffer at the target flow rate for 10 MV or until the UV280, pH, pressure, and conductivity detectors reach a constant value.
4. Steps D1 to D6 are repeated as needed at the remaining flowrates ranging from 7-10 MV/min.
5. If the device will not be used in the same session for the rapid cycling study, then it is removed from the chromatography system, the inlet/outlet caps are reinstalled, and it is stored in a refrigerator.
6. The procedure for determining the appropriate operating flow rate is described in the next section

TABLE 1
Suggested conditions to measure device pressure
vs flow rate for a 1 mL device.

| | | | Residence | Flow Rate | Volume |
|---|---|---|---|---|---|
| Step | Description | Buffer | Time (sec) | (mL/min) | (mL) |
| P1 | pump wash | equilibration | — | 20 | 10 |
| | equilibration | buffer | 8.6-7.5-6.7-6 | 7-8-9-10 | 10 |
| P2 | pump wash | high salt | — | 20 | 10 |
| | wash 2 | buffer | 8.6-7.5-6.7-6 | 7-8-9-10 | 10 |
| P3 | pump wash | equilibration | — | 20 | 10 |
| | wash 1 | buffer | 8.6-7.5-6.7-6 | 7-8-9-10 | 10 |
| P4 | pump wash | elution buffer | — | 20 | 10 |
| | elute | | 8.6-7.5-6.7-6 | 7-8-9-10 | 15 |
| P5 | pump wash | CIP solution | — | 20 | 10 |
| | CIP | | 8.6-7.5-6.7-6 | 7-8-9-10 | 10 |
| P6 | pump wash | equilibration | — | 20 | 10 |
| | equilibrate | buffer | 8.6-7.5-6.7-6 | 7-8-9-10 | 10 |

Flow Rate Determination

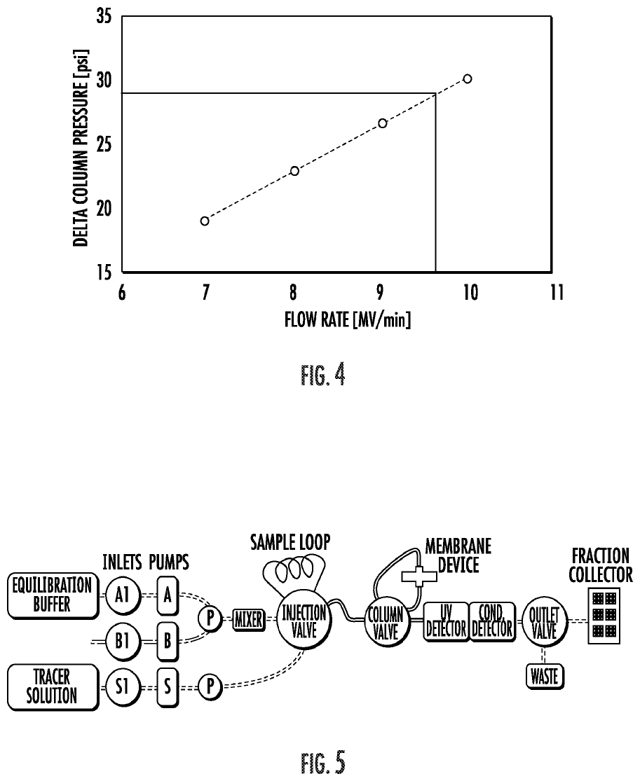

In order to optimize the flow rate, the maximum operating pressure is first determined for each of the flow rates. This typically occurs during the CIP and will yield a pressure-flow curve similar to the one shown in FIG. 4.

The optimized flow rate can then be determined by linear interpolation, as shown in the equation below:

$${Q}_{o p} = {Q}_{1} + \frac{{Q}_{2} - {Q}_{1}}{{P}_{2} - {P}_{1}} ( {P}_{o p} - {P}_{1} )$$

where Qₒₚ is the determined operating flow rate, Pₒₚ is the target operating delta column pressure drop of 2 bar. P₁ and P₂ are the two observed pressures, closest to 2 bar, and Q₁ and Q₂ are the corresponding flow rates.

It is recommended that the subsequent experiments be performed at said flow rate.

System Hold-Up Volume

Description of System Hold-Up Volume

The system hold-up volume is the volume between the injection valve and the detector (FIG. 5). This can be determined by equilibrating the device with the equilibration buffer and then injecting a tracer solution pulse (2% acetone, high salt solution). The retention volume of the observed peak is the system hold-up volume.

Measurement of System Hold-Up Volume
1. Equilibration buffer is flowed at the target flow rate through the device and the UV280 or conductivity detector is monitored to establish a baseline signal.
2. A tracer solution is loaded into a 100 μL sample loop.
3. The tracer solution is injected while continuing to flow equilibration buffer at the target flow rate. The time/volume will be set to zero at this injection event.
4. If the peak is split or otherwise severely distorted the device might not be integral and the evaluation should be discontinued.
5. The observed peak maximum volume is the system hold-up volume.

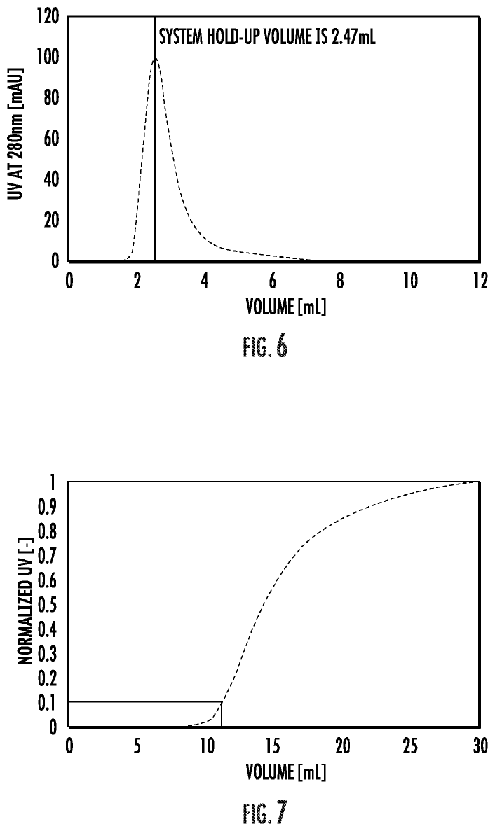

An example of the chromatogram generated during the measurement of the system hold-up volume with a 1 mL device is shown in FIG. 6.
6. The system hold-up volume typically ranges from 2 to 6 mL. The device and chromatography system will each contribute 1-3 mL. If the measured system hold-up volume is significantly larger, the hold-up volume of the chromatography system may be measured alone by replacing the device with the zero-volume connector.

Dynamic Binding Capacity

Dynamic Binding Capacity Feed Preparation

Preferably the dynamic binding capacity is determined using a pre-purified mAb solution. The breakthrough of the mAb can then be observed by monitoring the UV280 signal. The purified mAb solution should have similar concentration, pH and conductivity to the mAb feed that will be used for the rapid cycling study. The device should be loaded to about 50 g/L to fully observe the breakthrough behavior.

If a purified mAb solution is not available, then clarified mAb feed also can be used to determine the dynamic binding capacity. As the UV detector will be saturated at 280 nm when using a clarified cell culture, a longer wavelength, such as 300 nm should be used in this case. Alternatively, greater accuracy can be achieved using the procedure described by Swinnen et al. where mAb breakthrough volume fractions are collected and the corresponding mAb concentrations are measured offline by analytical Protein A chromatography (J. Chromatograph. B, 848 (2007) 97-107).

Dynamic Binding Capacity Method
1. The buffers and the mAb feed are prepared for the dynamic binding capacity measurement. Table 1 gives approximate quantities of buffer to be prepared for a single dynamic binding capacity measurement of the device:

TABLE 1
Volumes of buffers required for dynamic binding capacity
and rapid cycling experiments for a single 1 mL device.

| | | Anticipated |
|---|---|---|
| Description | Composition | Total (L) |
| equilibration buffer | PBS, TBS, etc. | 10 |
| high salt buffer | PBS, TBS, etc. + 1M NaCl | 5 |
| elution buffer | 50 mM acetate, pH 3.0* | 5 |
| CIP solution | 100 mM sodium hydroxide | 5 |

2. The mAb feed is connected through the sample pump and all the buffers are connected through either system pump A or system pump B.
3. The equilibration buffer is flowed at 10 mL/min over the column bypass until the UV280/UV300, pH, and conductivity detectors reach a constant value. Set the UV280/UV300 signal to zero.
4.mAb feed is flowed through the column bypass at 1 mL/min until the UV280/UV300 signal reaches a stable value. This value is recorded as it is the 100% breakthrough value and will be used to calculate the DBC₁₀ in the next section.
5. The equilibration buffer is flowed at 10 mL/min over the column bypass until the UV280/UV300, pH, and conductivity detectors reach a constant value. The UV280/300 signal should return to zero.
6. The following steps to measure the dynamic binding capacity are also shown in Table 3.
   a. Step D1: A 10 mL pump wash is used to prime the equilibration buffer. Equilibrate the device with 10 MV of equilibration buffer at the target flow rate
   b. Step D2: The 1 mL device is loaded with 50 mg of the mAb feed at the target flow rate.
   c. Step D3: The device is washed with 10 MV of the equilibration buffer at the target flow rate
   d. Step D4: A 10 mL pump wash is used to prime the high salt buffer. Wash the device with 10 MV of the high salt buffer at the target flow rate
   e. Step D5: A 10 mL pump wash is used to prime the equilibration buffer. Wash the device with 10 MV of the equilibration buffer at the target flow rate
   f. Step D6: A 10 mL pump wash is used to prime the elution. Elute the mAb from the device with 15 MV of the elution buffer at the target flow rate
   g. Step D7: A 10 mL pump wash is used to prime the CIP solution. Clean the device with 10 MV of CIP solution at a flow rate of at the target flow rate
   h. Step D8: A 10 mL pump wash is used to prime the equilibration buffer. The device is equilibrated with equilibration buffer at the target flow rate for 10 MV or until the UV280, pH, pressure, and conductivity detectors reach a constant value.
7. If the device will not be used in the same session for the rapid cycling study, then it is removed from the chromatography system, the inlet/outlet caps are installed, and it is stored in a refrigerator.
8. The DBC₁₀ value will be calculated by analyzing the chromatogram of the UV280 signal as is described in the next section.

TABLE 3
Dynamic binding capacity method for a 1 mL device.

| | | | Residence | Flow Rate | Volume |
|---|---|---|---|---|---|
| Step | Description | Buffer | Time (sec) | (mL/min) | (mL) |
| D1 | pump wash | equilibration | — | 20 | 10 |
| | equilibrate | buffer | target flow | target flow | 10 |
| D2 | load | mAb feed | target flow | target flow | 50 mg/ |
| | | | | | feed conc. |
| D3 | wash 1 | equilibration | target flow | target flow | 10 |
| | | buffer | | | |
| D4 | pump wash | high salt | — | 20 | 10 |
| | wash 2 | buffer | target flow | target flow | 10 |
| D5 | pump wash | equilibration | — | 20 | 10 |
| | wash 1 | buffer | target flow | target flow | 10 |
| D6 | pump wash | elution buffer | — | 20 | 10 |
| | elute | | target flow | target flow | 15 |
| D7 | pump wash | CIP solution | — | 20 | 10 |
| | CIP | | target flow | target flow | 10 |
| D8 | pump wash | equilibration | — | 20 | 10 |
| | equilibrate | buffer | target flow | target flow | 10 |

Calculating DBC₁₀
1. The UV signal is normalized by dividing it with the 100% breakthrough value measured in Step 4 of the “Dynamic binding capacity method” section (FIG. 7).
2. The loading volume at which the UV signal on the breakthrough curve reaches a value of 10% is located.
3. The dynamic binding capacity at 10% breakthrough is calculated according to:

$$D B {C}_{10} = \frac{( {V}_{10 \% BT} - {V}_{H U} ) \times {C}_{f e e d}}{{V}_{membrane}}$$

where the DBC₁₀ is the dynamic binding capacity at 10% breakthrough, V_{10%BT} is the volume of buffer when the UV signal reaches 10%, V_{HU} is the system hold-up volume, C_{feed} is the concentration of the mAb feed, and the V_{membrane} is the volume of membrane in the device.
4. For example, if the 10% breakthrough is 12.5 mL, the system hold-up volume is 2.47 mL, the mAb feed titer is 3 g/L, and the membrane volume is 1 mL, then the DBC₁₀ would be 30.1 g/L.

Rapid Cycling Study.

Time Length of Study

Preferably the device is evaluated for 100 cycles. A single bind/elute cycle will typically require 8-15 min depending on the loading density, the feed concentration, the operating flow rate, and the time required for pump washes on the LC device. Thus 13-25 hours would be required to complete 100 cycles.

Calculating the Volume of the mAb Feed Required

The volume of feed required for the rapid cycling study is calculated by the following formula:

$${V}_{f e e d} = \frac{{V}_{membane} \times L D}{{C}_{f e e d}} \times {N}_{cycles}$$

where the V_{feed} is the volume of the feed required, V_{membrane} is the volume of the membrane in the device, LD is the loading density, C_{feed} is the concentration of the mAb feed, and N_{cycles} is the number of cycles.

Note that the loading density is calculated according to the following formula:

LD=DBC₁₀×80%

For example, if the device was found to have DBC₁₀ of 30.1 g/L, then device loading would be 30.1 g/L×80% or 24.08 g/L. At a feed concentration of 1 g/L, 24.08 mL would have to be loaded per cycle and 2,408 mL would be required for 100 cycles. Note that an additional amount of feed should be prepared to prime the system and avoid completely emptying the feed container.

Rapid Cycling Method
1. The mAb feed and the buffers for the rapid cycling study are prepared. Table 1 above gives the quantities of buffer that should be prepared for a 100-cycle experiment using the 1 mL device.
2. Preferably the mAb feed is kept below 10° C. throughout the entirety of the cycling study.
3. The mAb feed is connected through the sample pump and all the buffers are connected through either system pump A or system pump B.
4. A single bind/elute cycle is described in the following steps and shown in Table 4. The cycling process should be automated on the chromatography system software. For example, on an AKTA system this is done by building the method using the “scouting” function in the “Method Editor” or using the “method queue” when setting up the experiment.
   a. Step R1: A 10 mL pump wash is used to prime the equilibration buffer. Equilibrate the device with 20 MV of equilibration buffer at the target flow rate.
   b. Step R2: The device is loaded with the mAb clarified cell culture to the loading density calculated above (80%×DBC₁₀). The feed should be primed to the injection valve before starting the first cycle. Subsequent cycles do not require priming.
   c. Step R3: The device is washed with 10 MV of equilibration buffer at a flow rate at the target flow rate.
   d. Step R4: A 10 mL pump wash is used to prime the high salt buffer. The device is washed with 10 MV of the high salt buffer at the target flow rate.
   e. Step R5: A 10 mL pump wash is used to prime the equilibration buffer. The device is washed with 10 MV of the equilibration buffer at the target flow rate.
   f. Step R6: A 10 mL pump wash is used to prime the elution buffer. The mAb is eluted from the device with 15 MV of the elution buffer at the target flow rate. Preferably every 10^{th} cycle the eluate is collected into 15 mL tubes when the UV₂₈₀ elution peak is above 100 mAU. The 100 mAU value may need to be adjusted for specific feeds.
   g. Step R7: A 10 mL pump wash is used to prime the CIP solution. The device is cleaned with 10 MV of CIP solution at the target flow rate.
5. After completing 100 cycles, the device is equilibrated with 35 MV of the equilibration buffer at the target flow rate or until the UV280, pH, pressure, and conductivity detectors reach a constant value.
6. If the full 100 cycles cannot be completed in a single session, then the device is flushed with equilibration buffer until the UV280, pH, pressure, and conductivity detectors reach a constant value. The device is removed from the chromatography system, the inlet/outlet caps are reinstalled, and it is stored in a refrigerator.

TABLE 4
Method for rapid cycling of a 1 mL device

| | | | Residence | Flow Rate | Volume |
|---|---|---|---|---|---|
| Step | Description | Buffer | Time (sec) | (mL/min) | (mL) |
| R1 | pump wash | equilibration | — | 20 | 10 |
| | equilibrate | buffer | target flow | target flow | 10 |
| R2 | load | clarified cell | — | 20 | 80% of |
| | | culture | | | DBC₁₀ |
| R3 | wash 1 | equilibration | target flow | target flow | 10 |
| | | buffer | | | |
| R4 | pump wash | high salt buffer | — | 20 | 10 |
| | wash 2 | | target flow | target flow | 10 |
| R5 | pump wash | equilibration. | — | 20 | 10 |
| | wash 1 | buffer | target flow | target flow | 10 |
| R6 | pump wash | elution buffer | — | 20 | 10 |
| | elute | | target flow | target flow | 15 |
| R8 | pump wash | CIP solution | — | 20 | 10 |
| | CIP | | target flow | target flow | 10 |

What is claimed is:

1. A chromatography device comprising a housing having a fluid inlet and a fluid outlet spaced from said inlet; an internal volume in said housing; at least first and second membranes arranged in said internal volume of said housing in a region between said fluid inlet and said fluid outlet, said first and second membranes each having an active membrane area through which fluid introduced into said fluid inlet can flow, and at least one spacer arranged between said first and second membranes, said at least one spacer having an opening in fluid communication with said active membrane area.

2. The chromatography device of claim 1, wherein said at least one spacer is in the shape of an annulus.

3. The chromatography device of claim 2, wherein there is a filtration zone within said internal volume defined by said active membrane area of said at least first and second membranes, and wherein said opening of said at least one spacer is arranged within said filtration zone.

4. The chromatography device of claim 1, wherein said first membrane is arranged upstream, in the direction of fluid flow during operation of said chromatography device, of said second membrane, said chromatography device further comprising a porous frit arranged between said fluid inlet and said first membrane.

5. The chromatography device of claim 3, further comprising a porous frit arranged between said fluid outlet and said second membrane.

6. The chromatography device of claim 1, wherein said at least first and second membranes and said at least one spacer are arranged in said housing such that, in operation of said device, fluid enters said fluid inlet, passes consecutively through said first membrane, said at least one spacer and said second membrane prior to exiting said housing through said fluid outlet.
